(19) United States
(12) Patent Application Publication
(10) Pub. No.: US 2009/0229074 A1
(43) Pub. Date: Sep. 17, 2009

(54) Dual-cyclone type dust collector and cleaner having the same

(75) Inventor: Jang-keun Oh, Gwangju-city (KR)

Correspondence Address: BLANK ROME LLP, WATERGATE, 600 NEW HAMPSHIRE AVENUE, N.W., WASHINGTON, DC, 20037, US

(73) Assignee: SAMSUNG GWANGJU ELECTRONICS CO., LTD.

(21) Appl. No.: 12/153,092

(22) Filed: May 14, 2008

(30) Foreign Application Priority Data
Jan. 2, 2008 (KR) 10-2008-0000421

(51) Int. Cl. A47L 9/16; B01D 45/12; B01D 46/42

(52) U.S. Cl. 15/353; 55/349; 96/416

(57) ABSTRACT

A dual-cyclone type dust collector having a compact size is provided, including a first dust collecting unit that includes a first cyclone chamber, a second dust collecting unit that includes a second cyclone chamber that is disposed at a diagonal to the first cyclone chamber, and a housing that receives the first dust collecting unit and the second dust collecting unit, and a part of which is formed as a wall of the first cyclone chamber and the second cyclone chamber.

### CROSS-REFERENCE TO RELATED APPLICATIONS

This application claims the benefit under 35 U.S.C. § 119 of Korean Patent Application No. 10-2008-00421, filed on Jan. 2, 2008, in the Korean Intellectual Property Office, the disclosure of which is incorporated herein by reference in its entirety.

### FIELD OF THE INVENTION

The present invention relates to a cleaner. More particularly, the present invention relates to a compact dual-cyclone type dust collector, and a cleaner having the same.

### BACKGROUND OF THE INVENTION

A conventional cleaner includes a cleaner body, a brush assembly, a brush pipe, and a flexible suction hose. The cleaner body generates suction force to draw dust-laden air into the brush assembly using a motor which is mounted in the cleaner body. The brush assembly sucks in dust-laden air while in contact with a surface being cleaned. The drawn-in dust-laden air reaches the dust collector mounted on the cleaner body through the brush pipe extending from the brush assembly and the suction hose.

The dust collector separates dust from the dust-laden air. A cyclone dust collector using a cyclone principle is generally used as such a dust collector. The cyclone dust collector separates dust from dust-laden air using centrifugal force by spinning dust-laden air rapidly. In order to raise the dust-separating efficiency, a dual-cyclone type dust collector having two cyclone chambers may be used. However, such a dual-cyclone type dust collector has the problem that it is difficult to construct with a compact size since the dual-cyclone type dust collector must use two cyclone chambers.

### SUMMARY OF THE INVENTION

Accordingly, to solve at least the above problems and/or disadvantages and to provide at least the advantages described below, a non-limiting object of the present invention is to provide a dual-cyclone type dust collector which has a compact size.

Another non-limiting object of the present invention is to provide a cleaner having the above dual-cyclone type dust collector.

According to an exemplary aspect of the present invention, there is provided a dual-cyclone type dust collector including a first dust collecting unit that includes a first cyclone chamber, a second dust collecting unit that includes a second cyclone chamber that is disposed at a diagonal to the first cyclone chamber, and a housing that receives the first dust collecting unit and the second dust collecting unit, and a part of which is formed as a wall of the first cyclone chamber and the second cyclone chamber.

The dual-cyclone type dust collector may further include a partition that isolates the first dust collecting unit and the second collecting unit.

The first dust collecting unit may include a first air inlet duct that is connected to the first cyclone chamber, and the second dust collecting unit may include a second air inlet duct that is connected to the second cyclone chamber, wherein inlets of the first air inlet duct and the second air inlet duct are formed on the same surface of the housing.

The one of the first air inlet duct and the second air inlet duct that is located further inside the housing may have a slant so that dust can fall therefrom.

The first dust collecting unit may include a first discharge duct that discharges air from the first cyclone chamber, and the second dust collecting unit may include a second discharge duct that discharges air from the second cyclone chamber.

A grill may be formed between the first cyclone chamber and the first discharge duct, and between the second cyclone chamber and the second discharge duct.

The first discharge duct and the second discharge duct may be formed pointing downwards, and a stabilizer pipe may be formed in the first cyclone chamber and the second cyclone chamber.

The dual-cyclone type dust collector may further include a handle that is grasped by a user.

The first dust collecting unit may include a first dust collecting chamber that collects dust separated by the first cyclone chamber, and the second dust collecting unit may include a second dust collecting chamber that collects dust separated by the second cyclone chamber.

The housing may be formed of a transparent material.

The housing may be formed of a translucent material.

The housing may be a rectangular parallelepiped.

The dual-cyclone type dust collector may further include a lower cover that is detachably mounted on the housing.

According to another exemplary aspect of the present invention, there is provided cleaner including a brush assembly that draws dust in contact with a surface being cleaned, a cleaner body that is connected to the brush assembly and includes a vacuum generation means, and a dual-cyclone type dust collector that is detachably mounted on the cleaner body.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a perspective view illustrating a cleaner according to an exemplary embodiment of the present invention;

FIG. 2 is a perspective view illustrating a dual-cyclone type dust collector according to an exemplary embodiment of the present invention;

FIG. 3 is a top view illustrating the dual-cyclone type dust collector of FIG. 2;

FIG. 4 is a sectional top view illustrating the dual-cyclone type dust collector of FIG. 2;

FIG. 5 is a sectional view illustrating the dual-cyclone type dust collector taken along a line V-V of FIG. 3; and

FIG. 6 is a sectional view illustrating the dual-cyclone type dust collector taken along a line VI-VI of FIG. 3.

### DETAILED DESCRIPTION OF EXEMPLARY EMBODIMENTS OF THE INVENTION

Reference will now be made in detail to non-limiting embodiments of the present invention by way of reference to the accompanying drawings, wherein like reference numerals refer to like parts, components and structures.

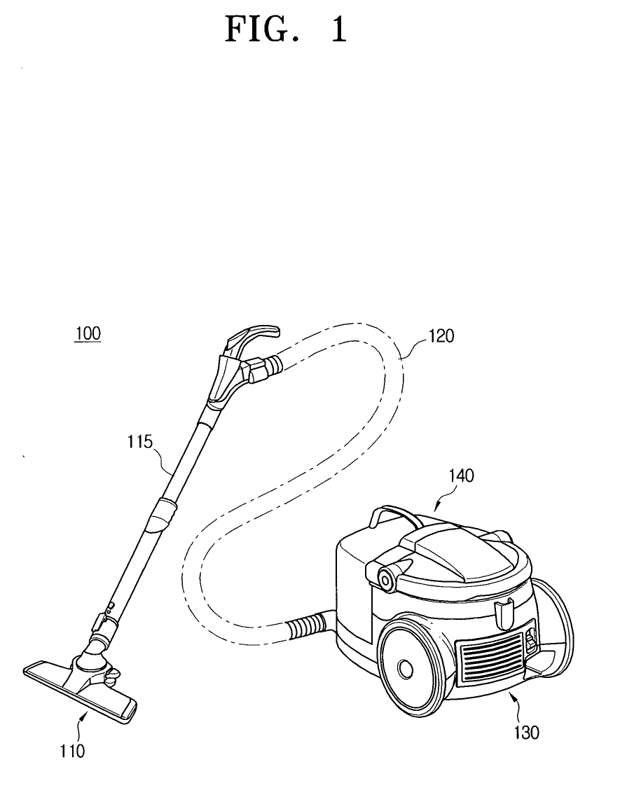

FIG. 1 is a perspective view illustrating a cleaner according to an exemplary embodiment of the present invention.

The cleaner includes a brush assembly 110, an extension pipe 115, a suction hose 120, a cleaner body 130, and a dual-cyclone type dust collector 140.

The brush assembly 110 draws dust-laden air while in contact with a surface being cleaned. The dust-laden air reaches the dual-cyclone type dust collector 140 mounted on the cleaner body 130 via the extension pipe 115 extending from the brush assembly 110 and the flexible suction hose 120. The cleaner body 130 generates a suction force using a vacuum generation means such as a motor. The dual-cyclone type dust collector 140 separates dust from the air using two dust collecting units in a cyclone manner, and is detachably mounted on the cleaner body 130.

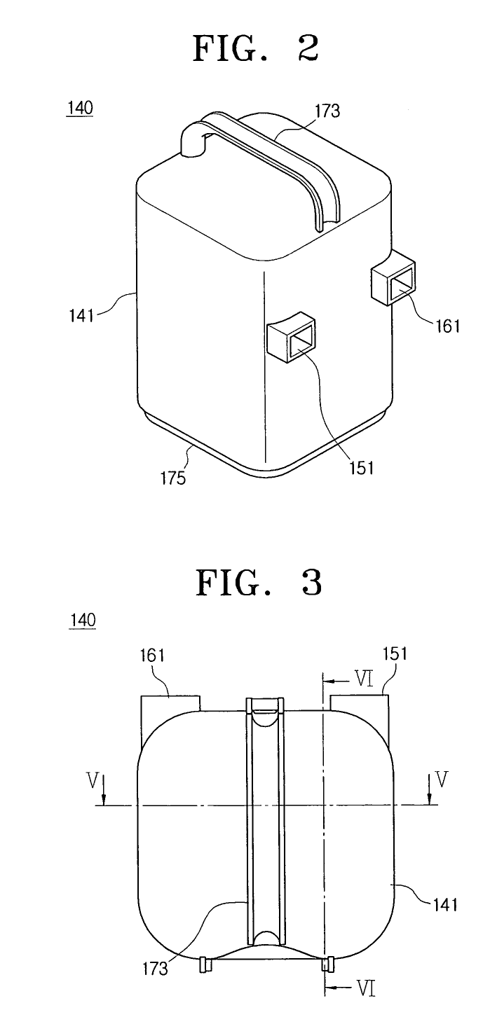

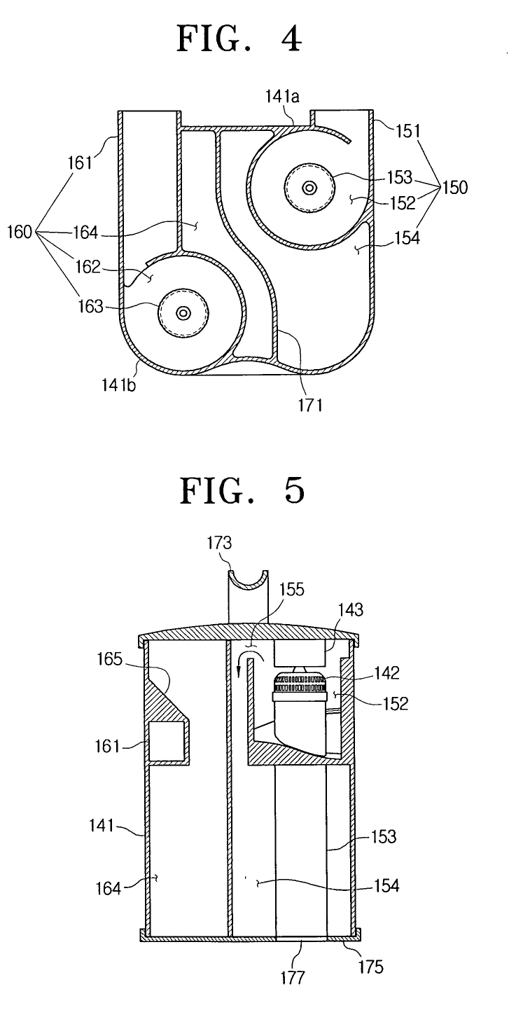

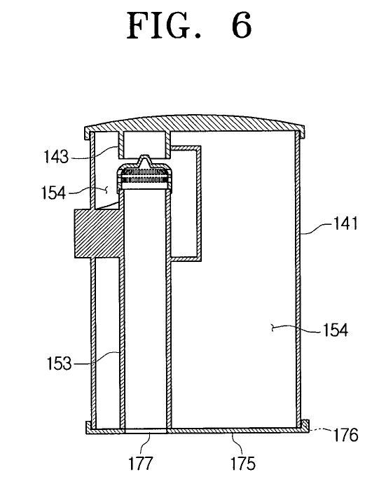

FIG. 2 is a perspective view illustrating the dual-cyclone type dust collector 140 according to an exemplary embodiment of the present invention, FIG. 3 is a top view illustrating the dual-cyclone type dust collector 140, FIG. 4 is a sectional top view illustrating the dual-cyclone type dust collector 140, FIG. 5 is a sectional view illustrating the dual-cyclone type dust collector taken along a line V-V of FIG. 3, and FIG. 6 is a sectional view illustrating the dual-cyclone type dust collector taken along a line VI-VI of FIG. 3.

The dual-cyclone type dust collector 140 includes a housing 141, a first dust collecting unit 150, a second dust collecting unit 160, a partition 171, a handle 173, and a lower cover 175.

The housing 141 forms the exterior of the dual-cyclone type dust collector 140. The housing 141 receives a first dust collecting unit 150 and a second dust collecting unit 160, and provides space for storing dust collected by a first dust collecting chamber 154 and a second dust collecting chamber 164. In order to make the dual-cyclone type dust collector having the two dust collecting units compact, the housing 141 may be a rectangular parallelepiped as shown in FIG. 2, but is not limited thereto. The housing 141 may be formed of a transparent, translucent, or opaque material. If the housing 141 is formed of a transparent or translucent material, the user can directly realize the amount of dust collected in the first and second dust collecting chambers 154 and 164. In addition, since the wall of the first and second cyclones 152 and 162 constitutes a part of the exterior of the housing 141, if the housing 141 is formed of a transparent or translucent material, the user can view the operation of dust being separated from dust-laden air using the first and second dust collecting chambers 154 and 164.

The first dust collecting unit 150 includes a first air inlet duct 151, a first cyclone chamber 152, a first discharge duct 153, and a first dust collecting chamber 154.

The first air inlet duct 151 guides dust-laden air to the first cyclone chamber 152.

The first cyclone chamber 152 separates dust from the air in a cyclone manner. In this exemplary embodiment of the present invention, the first cyclone chamber 152 is disposed in the upper right of the housing 141 as shown in FIG. 4.

The first discharge duct 153 discharges dust-separated air from the first cyclone chamber 152. A grill 142 is disposed between the first cyclone chamber 152 and the first discharge duct 153 to completely prevent separated dust from being discharged externally through the first discharge duct 153.

The first dust collecting chamber 154 collects dust separated by the first cyclone chamber 152. As shown in FIG. 5, the first cyclone chamber 152 is connected to the first dust collecting chamber 154 through a connection hole 144. The dust is separated by a centrifugal force, and moves in the direction of the arrow of FIG. 5 through the first connection hole 155 to the first dust collecting chamber 154.

As shown in FIG. 5, the first discharge duct 153 may be formed pointing downwards, so that air separated by the first cyclone chamber 152 can be discharged through a lower surface of one side of the dual-cyclone type dust collector 140. In order to help dust move into the first dust collecting chamber 154 through the first connection hole 155, a stabilizer pipe 143 is formed in the first cyclone chamber 152. Since the stabilizer pipe 143 is known in the related art, detailed description is omitted here.

The second dust collecting unit 160 includes a second air inlet duct 161, a second cyclone chamber 162, a second discharge duct 163, and a second dust collecting chamber 164. Since the second dust collecting unit 160 has the same configuration and function as the first dust collecting unit 150, only the distinct features of the first dust collecting unit 150 are described here.

The second cyclone chamber 162 separates dust from dust-laden air. The second cyclone chamber 162 according to this exemplary embodiment of the present invention is disposed in the lower left of the housing 141 as shown in FIG. 4. That is, the first and second cyclone chambers 152 and 162 are diagonally arranged in the housing 141 as shown in FIG. 4, so the compact configuration of the dual cyclone type dust separator 140 is enabled. In this exemplary embodiment of the present invention, as shown in FIG. 4, the first cyclone chamber 152 is disposed in the upper right of the dual cyclone type dust separator 140, and the second cyclone chamber 162 is disposed in the lower left. However, the arrangement is not limited thereto, but instead the first cyclone chamber 152 may be disposed in the lower right, and the second cyclone chamber 162 may be disposed in the upper left.

In order to implement the compact configuration of the dual-cyclone type dust collector 140, the wall of the first and second cyclone chambers 152 and 162 constitutes a part of the exterior of the housing 141. Referring to FIG. 4, in the upper right, a part 141a of the housing 141 forms the wall of the first cyclone chamber 152, and in the lower left, a part 141b of the housing 141 forms the wall of the second cyclone chamber 162. This configuration enables the dual-cyclone type dust collector 140 to be made compactly, and thus leads to the miniaturization of the cleaner body 130. Compared with a dust collector having the same volume, the space available for the first and second dust collecting chambers 154 and 164 is greater, and so more dust can be collected. As a result, the user can dump the collected dust less frequently.

As shown in FIGS. 2, 3, and 4, the inlets of the first and second air inlet ducts 151 and 161 are formed on the same surface of the housing 141, so miniaturization of the cleaner body 130 is enabled. The cleaner body 130 has an air path along which dust-laden air which has been drawn into the brush assembly 110 moves towards the first and second air inlet ducts 151 and 161, so the cleaner body 130 needs space for forming the air path connected to the first and second air inlet ducts 151 and 161. An unnecessary increase in the size of the cleaner body 130 can be prevented by forming the first and second air inlet ducts 151 and 161 on the same surface.

In this exemplary embodiment of the present invention, since the first and second cyclone chambers 152 and 162 are arranged diagonally and the inlets of the first and second air inlet ducts 151 and 161 are formed on the same surface of the housing 141, the second air inlet duct 161 connected to the second cyclone chamber 162 is located further inside the housing as shown in FIGS. 4 and 5. Accordingly, dust in the second dust collecting chamber 164 may pile up on an upper surface of the second air inlet duct 161. In order to prevent this, the second air inlet duct 161 is configured to have a slant 165, so dust can be dropped into the second dust collecting chamber 164 instead of piling up on the second air inlet duct 161.

However, since the first air inlet duct 151 is near the first cyclone chamber 152 which is disposed in the upper right in FIG. 4, the first air inlet duct 151 does not need to have a slant. As described above, in FIG. 4, the first cyclone chamber 152 may be disposed in the lower right, and the second cyclone chamber 162 may be disposed in the upper left. In this case, since the first air inlet duct 151 is located further inside the housing, the first air inlet duct 151 needs to have a slant.

The partition 171 isolates the first and second dust collecting units 150 and 160, and has an “S” shape, as shown in FIG. 4.

The handle 173 is formed on the upper surface of the dual-cyclone type dust collector 140 to be grasped by the user, so the user can attach or detach the dual-cyclone type dust collector 140 to or from the cleaner body 130 by holding the handle 173.

The lower cover 175 is detachably formed on the housing 141. According to this exemplary embodiment of the present invention, the lower cover 175 can rotate about a hinge axis 176 as shown in FIG. 6. If the first and second dust collecting chambers 154 and 164 are full of dust, the user can open the lower cover 175 and dump the dust. As shown in FIGS. 5 and 6, a filter member 177 is formed corresponding to the first discharge duct 153, and so removes fine dust by filtering air again in which dust is primarily separated by the first cyclone chamber 152. The filter member 177 is also formed corresponding to the second discharge duct 163.

As can be appreciated from the above description of the dual cyclone type dust separating apparatus, since two cyclone chambers are disposed diagonally and a part of the housing constitutes the wall of the cyclone chambers, compact configuration of the dual cyclone type dust separating apparatus is enabled. As a result, the cleaner body can be miniaturized.

While certain exemplary embodiments of the present invention have been shown and described with reference to certain preferred embodiments thereof, it will be understood by those skilled in the art that various changes in form and details may be made therein without departing from the spirit and scope of the invention as defined by the appended claims and their equivalents.

What is claimed is:

1. A dual-cyclone type dust collector, comprising:
a first dust collecting unit that comprises a first cyclone chamber;
a second dust collecting unit that comprises a second cyclone chamber that is disposed at a diagonal to the first cyclone chamber; and
a housing that comprises the first dust collecting unit and the second dust collecting unit, and a part of which is formed as a wall of the first cyclone chamber and the second cyclone chamber.

2. The dual-cyclone type dust collector of claim 1, further comprising:
a partition that isolates the first dust collecting unit from the second collecting unit.

3. The dual-cyclone type dust collector of claim 1, wherein the first dust collecting unit comprises a first air inlet duct that is connected to the first cyclone chamber, and the second dust collecting unit comprises a second air inlet duct that is connected to the second cyclone chamber,
wherein inlets of the first air inlet duct and the second air inlet duct are formed on the same surface of the housing.

4. The dual-cyclone type dust collector of claim 3, wherein one of the first air inlet duct and the second air inlet duct that is located further inside the housing has a slant so that dust can fall therefrom.

5. The dual-cyclone type dust collector of claim 1, wherein the first dust collecting unit comprises a first discharge duct that discharges air from the first cyclone chamber, and the second dust collecting unit comprises a second discharge duct that discharges air from the second cyclone chamber.

6. The dual-cyclone type dust collector of claim 5, further comprising a first grill connected between the first cyclone chamber and the first discharge duct, and a second grill connected between the second cyclone chamber and the second discharge duct.

7. The dual-cyclone type dust collector of claim 5, wherein the first discharge duct and the second discharge duct are formed pointing downwards, a first stabilizer pipe is formed in the first cyclone chamber, and a second stabilizer pipe is formed in the second cyclone chamber.

8. The dual-cyclone type dust collector of claim 1, further comprising:
a handle coupled to the housing.

9. The dual-cyclone type dust collector of claim 1, wherein the first dust collecting unit comprises a first dust collecting chamber that collects dust separated by the first cyclone chamber, and the second dust collecting unit comprises a second dust collecting chamber that collects dust separated by the second cyclone chamber.

10. The dual-cyclone type dust collector of claim 1, wherein the housing is formed of a transparent material.

11. The dual-cyclone type dust collector of claim 1, wherein the housing is formed of a translucent material.

12. The dual-cyclone type dust collector of claim 1, wherein the housing is a rectangular parallelepiped.

13. The dual-cyclone type dust collector of claim 1, further comprising:
a lower cover that is detachably mounted on the housing.

14. A cleaner, comprising:
a brush assembly that draws dust in contact with a surface being cleaned;
a cleaner body that is connected to the brush assembly and comprises a vacuum generation means; and
a dual-cyclone type dust collector that is detachably mounted on the cleaner body,
wherein the dual-cyclone type dust collector comprises:
a first dust collecting unit that comprises a first cyclone chamber;
a second dust collecting unit that comprises a second cyclone chamber that is disposed at a diagonal to the first cyclone chamber; and
a housing that comprises the first dust collecting unit and the second dust collecting unit, and a part of which is formed as a wall of the first cyclone chamber and the second cyclone chamber.

15. The cleaner of claim 14, further comprising:
a partition that isolates the first dust collecting unit from the second dust collecting unit.

16. The cleaner of claim 14, wherein the first dust collecting unit comprises a first air inlet duct that is connected to the first cyclone chamber, and the second dust collecting unit comprises a second air inlet duct that is connected to the second cyclone chamber,
wherein inlets of the first air inlet duct and the second air inlet duct are formed on the same surface of the housing.

17. The cleaner of claim 16, wherein one of the first air inlet duct and the second air inlet duct that is located further inside the housing has a slant so that dust can fall therefrom.

18. The cleaner of claim 14, wherein the first dust collecting unit comprises a first discharge duct that discharges air from the first cyclone chamber, and the second dust collecting unit comprises a second discharge duct that discharges air from the second cyclone chamber.

19. The cleaner of claim 18, further comprising a first grill connected between the first cyclone chamber and the first discharge duct, and a second grill connected between the second cyclone chamber and the second discharge duct.

20. The cleaner of claim 19, wherein the first discharge duct and the second discharge duct are formed pointing downwards, a first stabilizer pipe is formed in the first cyclone chamber, and a second stabilizer pipe is formed in the second cyclone chamber.

21. The cleaner of claim 14, further comprising:
a handle coupled to the housing.

22. The cleaner of claim 15, wherein the first dust collecting unit comprises a first dust collecting chamber that collects dust separated by the first cyclone chamber, and the second dust collecting unit comprises a second dust collecting chamber that collects dust separated by the second cyclone chamber.

23. The cleaner of claim 14, wherein the housing is formed of a transparent material.

24. The cleaner of claim 14, wherein the housing is formed of a translucent material.

25. The cleaner of claim 14, wherein the housing is a rectangular parallelepiped.

26. The cleaner of claim 14, further comprising:
a lower cover that is detachably mounted on the housing.
